(19) United States
(12) Patent Application Publication
(10) Pub. No.: US 2009/0046145 A1
(43) Pub. Date: Feb. 19, 2009

(54) Lower Perspective Camera for Review of Clothing Fit and Wearability and Uses Thereof

(76) Inventor: Thomas Simon, Scottsdale, AZ (US)

Correspondence Address: BUCHALTER NEMER, 18400 VON KARMAN AVE., SUITE 800, IRVINE, CA, 92612, US

(21) Appl. No.: 12/191,987

(22) Filed: Aug. 14, 2008

Related U.S. Application Data
(60) Provisional application No. 60/955,897, filed on Aug. 15, 2007.

(51) Int. Cl. H04N 7/18

(52) U.S. Cl. 348/77; 348/E07.085

(57) ABSTRACT

Methods of providing a rear perspective viewing for a consumer in a retail clothing store include: a) providing an image system; b) providing a receiver, wherein the image system collects an actual image of a person and transmits the image to the receiver, c) providing at least one monitor, wherein at least one of the at least one monitor is located at least 90 degrees from the image system and wherein the at least one monitor receives the actual image from the receiver; and d) providing a retail clothing space comprising the image system and the at least one monitor.

This application is a United States Utility Application that claims priority to U.S. Provisional Application Ser. No.: 60/955897 filed on Aug. 15, 2007, which is incorporated herein by reference in its entirety.

### FIELD OF THE SUBJECT MATTER

The field of the subject matter is a lower perspective camera for review of clothing fit and wearability, along with uses of the camera.

### BACKGROUND

Clothing shoppers, especially women, have been looking for the perfect way to see how their clothing purchases fit—both from the front and from the back for many years. Women are either forced to contort to awkward positions to look in a three-way mirror or invite a friend into the dressing room to see how clothing fits from the back. In both instances, the person trying on the clothes does not get a true perspective of how the clothing fits from the back.

In addition, clothing shoppers have been looking for a way to try on clothing in a virtual environment before trying on clothes in the real-world, in order to narrow down choices and minimize the time shopping for that perfect outfit. There are current systems that have been developed that will take a “photo” or store a visual representation of a customer, produce a virtual “customer” who has the same dimensions as the real customer and allow the customer to try on several virtual outfits in order to determine if that outfit looks good on their body type. However, many consumers when shopping for clothing wants to “get in and get out” by trying a particular piece on quickly, see how it fits and make an immediate decision as to whether to purchase. In these instances, a customer isn't interested in going through a long process of seeing how multiple clothing options at one store fit on his/her body.

Therefore, it would be ideal to develop a real-time camera system that is designed to transmit and provide a “rear perspective” or multiple perspectives where the customer can view an immediate image of the back of the consumer.

### SUMMARY

Methods of providing a rear perspective viewing for a consumer in a retail clothing store include: a) providing an image system; b) providing a receiver, wherein the image system collects an actual image of a person and transmits the image to the receiver, c) providing at least one monitor, wherein at least one of the at least one monitor is located at least 90 degrees from the image system and wherein the at least one monitor receives the actual image from the receiver; and d) providing a retail clothing space comprising the image system and the at least one monitor.

### BRIEF DESCRIPTION OF THE FIGURES

FIG. 1 shows how a consumer would use this lower perspective camera to get a true and correct image of the rear perspective of that consumer.

FIG. 2 shows an embodiment of a shopping area or store layout that would include dressing rooms and dressing areas containing contemplated lower perspective cameras.

### DETAILED DESCRIPTION

In an effort to address this need for a “rear perspective” or multiple perspectives, a real-time camera and/or image system has been developed that is designed to transmit and provide a “rear perspective” or multiple perspectives where the customer can view an immediate image of the back of the consumer.

Specifically, methods of providing a rear perspective viewing for a consumer in a retail clothing store include: a) providing an image system; b) providing a receiver, wherein the image system collects an actual image of a person and transmits the image to the receiver, c) providing at least one monitor, wherein at least one of the at least one monitor is located at least 90 degrees from the image system and wherein the at least one monitor receives the actual image from the receiver; and d) providing a retail clothing space comprising the image system and the at least one monitor.

In contemplated systems, actual, real-time images are transmitted from an image system through a receiver to at least one monitor or television in the retail area. The at least one monitor may be located on a wall, suspended from the ceiling, mounted on the floor or any other suitable location. The at least one monitor may also be mounted on or designed as part of a mirror, such that the user can see both the front and back perspective views at the same time. Contemplated monitors may be those devices that are separate from the mirror, such as a television or computer monitor. Contemplated monitors may also be flat screen components, transparent components or layered components that can be formulated into or onto a mirrored surface.

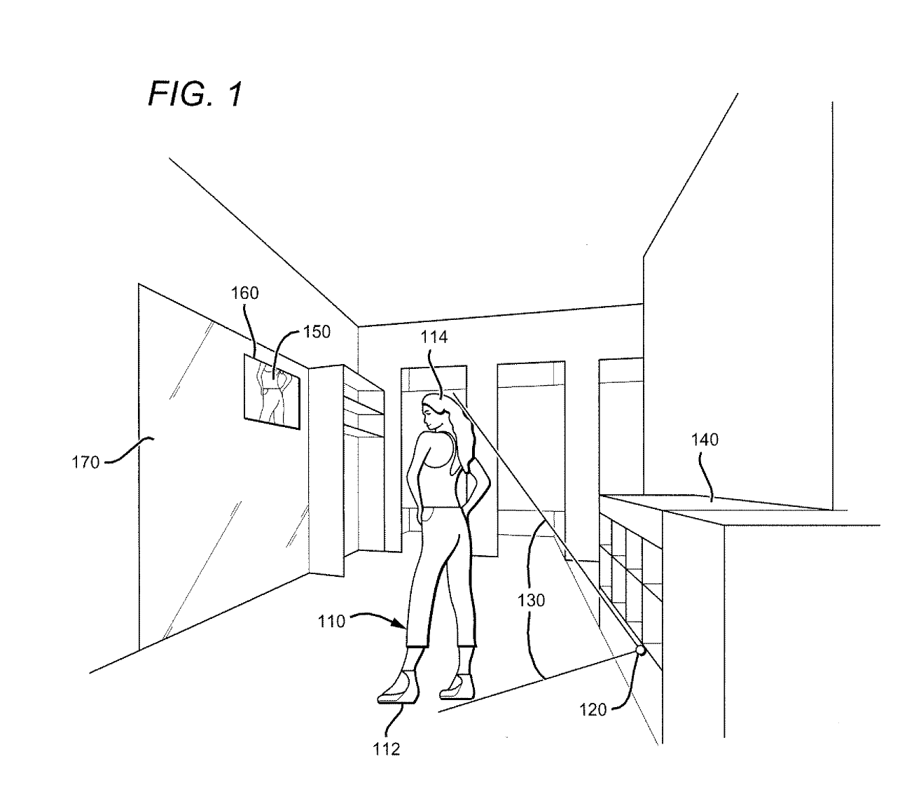

FIG. 1 shows how a consumer would use this lower perspective camera and/or image system to get a true and correct image of the rear perspective of that consumer. The consumer 110, in this embodiment, is standing in front of the camera 120, which has a viewing area 130 from the foot 112 to the head 114 of the consumer 110. The camera 120 is mounted into a end cap or cabinet fixture 140. The receiver (not shown) transmits the image 150 to a television 160 mounted on a mirror 170.

Cameras and/or image systems contemplated herein may be any suitable camera that can receive and transmit an image in realtime (and non-animated) to a receiver, which may be coupled with or integrated with either the camera or monitor, and then to monitor or television, while the consumer is trying on clothing. Contemplated cameras and/or image systems may be analog or digital depending on the needs of the space, the dressing room and the consumer.

Contemplated cameras and/or image systems may be powered up or on throughout the day, may activate and start collecting and transmitting images as soon as it is activated by movement in the dressing area (motion activated) or a combination thereof. It should be understood that the camera/image system should not be used in areas considered “private” areas, but instead are intended for those areas that are considered public areas, such as immediately outside of a dressing room or in another public area of a store. These image systems may also be installed in homes, in order to provide the user with a real-time view of his or her entire outfit.

Contemplated cameras and/or image systems may transmit color or black and white images, depending on the needs of the vendor or the consumer. In addition, at least one camera and/or image system may be placed at different points in the dressing room or dressing area in order to provide additional perspectives of the consumer, including from the top side, from the left, from the right, from the back or any other desirable view. Each of these images can be transmitted to and displayed on a suitable monitor, including a computer monitor, a flat panel television, a high definition monitor or a combination thereof.

In contemplated embodiments, real-time actual images of the consumer or customer are captured and transmitted to the consumer on the monitor. It should be understood that the image system is designed to show the actual consumer or customer in real-time with the current clothing on his/her body. The system is not designed to transmit an animated image of the customer to the customer in real-time or as the only image presented.

In an additional embodiment, contemplated cameras may be designed to additionally collect head to toe data about the shopper in order to provide a “computer animation” version of the shopper. This function is useful to store information about the shopper, provide an animation representation of the shopper in order to show that shopper in other clothing without having to physically try items on, to keep a log of the shoppers size and profile or a combination thereof. This technology is similar to the technology utilized to take human form and convert it to a video game or animation format.

Contemplated camera and monitor combinations may be utilized to record individual shoppers in order to provide a “take away” item showing the shopper in various outfits, in case the shopper wants to pre-screen purchases or order later from an online source.

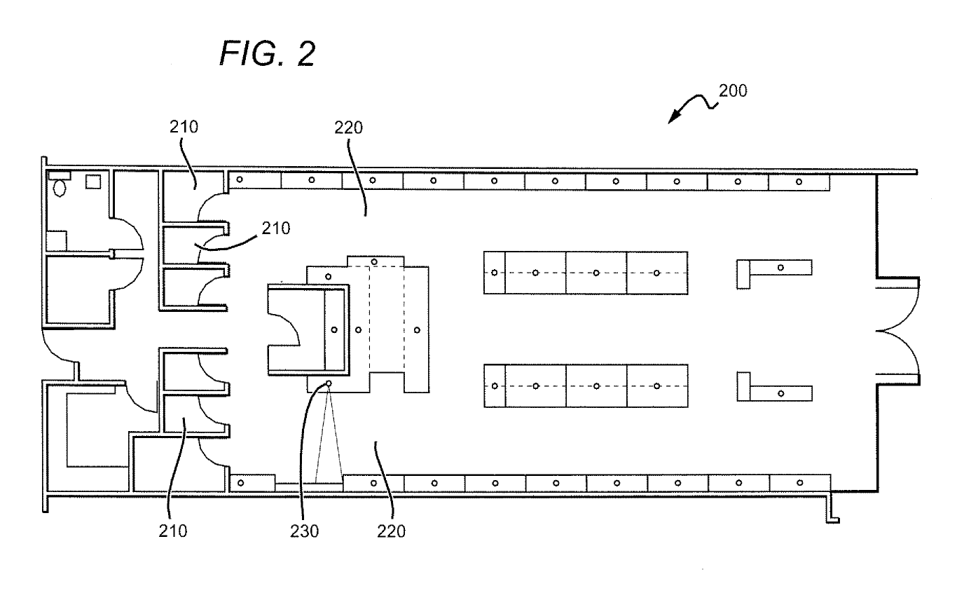

FIG. 2 shows a contemplated layout of a shopping area or store layout 200 that would include dressing rooms 210 and dressing areas 220 containing contemplated lower perspective cameras 230. It should be noted that in some contemplated embodiments, the monitor is located between 90 and 180 degrees from the image system. In other embodiments, the monitor is located 180 degrees from the image system.

Thus, specific embodiments and applications of a lower perspective camera for review of clothing fit and wearability, along with uses of the camera have been disclosed. It should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A method of providing a rear perspective viewing for a consumer in a retail clothing store, comprising:
providing an image system;
providing a receiver, wherein the image system collects an actual image of a person and transmits the image to the receiver,
providing at least one monitor, wherein the monitor is located at least 90 degrees from the image system and wherein the monitor receives the actual image from the receiver; and
providing a retail clothing space comprising the image system and the at least one monitor.

2. The method of claim 1, wherein the image of a person is a non-animated image.

3. The method of claim 1, wherein the image of a person is a non-animated image of the person and at least one piece of clothing that the person is actually wearing.

4. The method of claim 1, wherein the image system comprises a fiber optic cable.

5. The method of claim 1, wherein the receiver and the at least one monitor are separate components.

6. The method of claim 1, wherein the receiver and the at least one monitor are contained within the same component.

7. The method of claim 1, wherein the at least one monitor comprises a computer monitor, a flat panel television, a high definition monitor or a combination thereof.

8. The method of claim 1, wherein at least one of the at least one monitor is located 180 degrees from the image system.

9. The method of claim 1 wherein the retail clothing space is a women's clothing store.

10. The method of claim 1, further comprising placing the image system and the monitor in proximity to and outside of a changing room, dressing room or dressing area.
